(19) United States
(12) Patent Application Publication
(10) Pub. No.: US 2021/0188149 A1
(43) Pub. Date: Jun. 24, 2021

(54) IN-VEHICLE APPLIANCE ATTACHMENT SYSTEMS

(71) Applicant: ZUME, INC., Mountain View, CA (US)

(72) Inventors: Pablo Gonzalez, Mountain View, CA (US); Paul Leeman, Mountain View, CA (US)

(73) Assignee: ZUME, INC., Mountain View, CA (US)

(21) Appl. No.: 16/721,322

(22) Filed: Dec. 19, 2019

(51) Int. Cl. B60P 7/08; B60P 3/025

(52) U.S. Cl. CPC B60P 7/0815; B60P 3/0257

(57) ABSTRACT

Technologies are generally described for in-vehicle appliance attachment systems. A re-configurable anchor system may include low profile support extrusions vertically attached to interior vehicle walls and horizontal rails with screw, track, and/or channel based securing mechanisms attached to the support extrusions. Configurable mounting connectors comprising a mounting block and a right-angle connection plate, held together by a security pin, may be attached to the horizontal rails and side or back of appliances. Depending on the configuration, the configurable mounting connectors may allow appliances to be arranged with minimal spacing between each other or between the appliances and the wall. The configurable mounting connectors may also be fitted with dampeners to reduce transmission of vehicle vibration to the appliances.

### BACKGROUND

Unless otherwise indicated herein, the materials described in this section are not prior art to the claims in this application and are not admitted to be prior art by inclusion in this section.

Conventional food supply chains often include a source or initial supplier of raw ingredients for food products for human consumption, such as plant-based or animal-based ingredients. The ingredients are often transported from the source to one or more processing facilities, where the raw ingredients are prepared into food products including one or more intermediate ingredients and eventually prepared into marketable food items intended for direct human consumption. The food items are then often transported from the processing facilities to locations where consumers can select and/or consume the food products, such as homes, grocery stores, restaurants, etc. Food items are normally processed in a plurality of facilities. The processed food items are then concentrated at a packing facility for packing. A lot of time is typically wasted during those processes, and during transit between the various facilities, generally resulting in a degradation of freshness of food items.

### SUMMARY

The present disclosure generally describes support extrusions and configurable mounting connectors for in-vehicle appliance attachment systems.

According to some examples, a re-configurable anchor system for en route food item preparation vehicles is described. The anchor system may include one or more frames that include a plurality of vertical support extrusions and a plurality of horizontal rails, where the plurality of vertical support extrusions are affixed to an interior wall of the vehicle and the plurality of horizontal rails are affixed to the plurality of vertical support extrusions; and a plurality of configurable mounting connectors. Each appliance may be attached to one or more of the plurality of horizontal rails through one or more pairs of configurable mounting connectors. The plurality of configurable mounting connectors may be configured to secure an appliance in a first configuration that allows reduced spacing between appliances or in a second configuration that allows reduced spacing between the appliance and the interior wall.

According to other examples, a configurable mounting connector may include a mounting block configured to attach to a horizontal rail of an anchor system and a right-angle connection plate removably attached to the mounting block. The right-angle connection plate may include an appliance portion with a hole for attachment to an appliance and a mounting block portion that includes a top part, a middle part, and a bottom part. The middle part may e attached to the appliance portion at a substantially right-angle, and the mounting block portion may be substantially “u” shaped such that the top part is aligned with a top surface of the mounting block and the bottom part is aligned with a bottom surface of the mounting block.

According to further examples, a method for arranging appliances in an en route food item preparation vehicle is described. The method may include attaching a first pair of configurable mounting connectors to a horizontal rail of a re-configurable anchor system of the vehicle, where each configurable mounting connector include a mounting portion attachable to the horizontal rail through one or more of a complementary track system, a complementary channel system, a screw coupling, or a nut/bolt coupling, and a right-angle connection plate removably attached to the mounting block. The method may also include attaching right-angle connection plates of the first pair of configurable mounting connectors to respective sides of a first appliance to arrange the first appliance in a first configuration that allows reduced spacing between appliances; attaching a second pair of configurable mounting connectors to the horizontal rail of the re-configurable anchor system of the vehicle; and attaching right-angle connection plates of the second pair of configurable mounting connectors to a back of the second appliance to arrange the second appliance in a second configuration that allows reduced spacing between the second appliance and the horizontal rail.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a high-level block diagram for an example en route food preparation and delivery system, which may use vehicles with preparation and storage appliances;

FIG. 2A includes examples of vehicles which may be used to process and deliver food items;

FIG. 2B includes an isometric interior view of an example container with a right-hand interior side wall cut away showing racks of heating and storage equipment as well as for processing appliances;

FIG. 2C includes a top plan view of an example vehicle with preparation and storage appliances attached to interior side walls of the vehicle through support extrusions and configurable mounting connectors;

FIG. 2D includes an isometric interior view of an example vehicle with preparation and storage appliances attached to interior side walls of the vehicle through support extrusions and configurable mounting connectors;

FIG. 3A includes a cutaway view of a food preparation appliance attached to a support system through support extrusions and dampened mounting connectors;

FIG. 3B includes a cutaway view of a food preparation appliance attached to a support system through support extrusions and configurable mounting connectors from a different perspective;

FIG. 4A includes a cross-sectional top view of a support extrusion;

FIG. 4B includes various isometric views of a support extrusion from different perspectives;

FIG. 5A includes a top view of a pair of configurable mounting connectors attached to an appliance in a zero wall footprint configuration, which allows appliances to be placed without spacing between each appliance;

FIG. 5B includes an isometric view of the pair of configurable mounting connectors of FIG. 5A in the zero wall footprint configuration;

FIG. 5C includes an isometric close-up view of a configurable mounting connector in the zero wall footprint configuration;

FIG. 5D includes a top close-up view of the configurable mounting connector in the zero wall footprint configuration;

FIG. 6A includes a top view of a pair of configurable mounting connectors attached to an appliance in an intrusion wall footprint configuration, which allows appliances to be placed with spacing between each appliance but closer to a wall;

FIG. 6B includes an isometric view of the pair of configurable mounting connectors of FIG. 6A in the intrusion wall footprint configuration;

FIG. 6C includes an isometric close-up view of a configurable mounting connector in the intrusion wall footprint configuration;

FIG. 6D includes a top close-up view of the configurable mounting connector in the intrusion wall footprint configuration; and

FIG. 7 includes an isometric close-up view of a configurable mounting connector in the zero wall footprint configuration with a vibration dampening element;

at least some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, and/or devices related to support extrusions and configurable mounting connectors for in-vehicle appliance attachment systems.

Briefly stated, technologies are generally described for in-vehicle appliance attachment systems. A re-configurable anchor system may include low profile support extrusions vertically attached to interior vehicle walls and horizontal rails with screw, track, and/or channel based securing mechanisms attached to the support extrusions. Configurable mounting connectors comprising a mounting block and a right-angle connection plate, held together by a security pin, may be attached to the horizontal rails and side or back of appliances. Depending on the configuration, the configurable mounting connectors may allow appliances to be arranged with minimal spacing between each other or between the appliances and the wall. The configurable mounting connectors may also be fitted with dampeners to reduce transmission of vehicle vibration to the appliances.

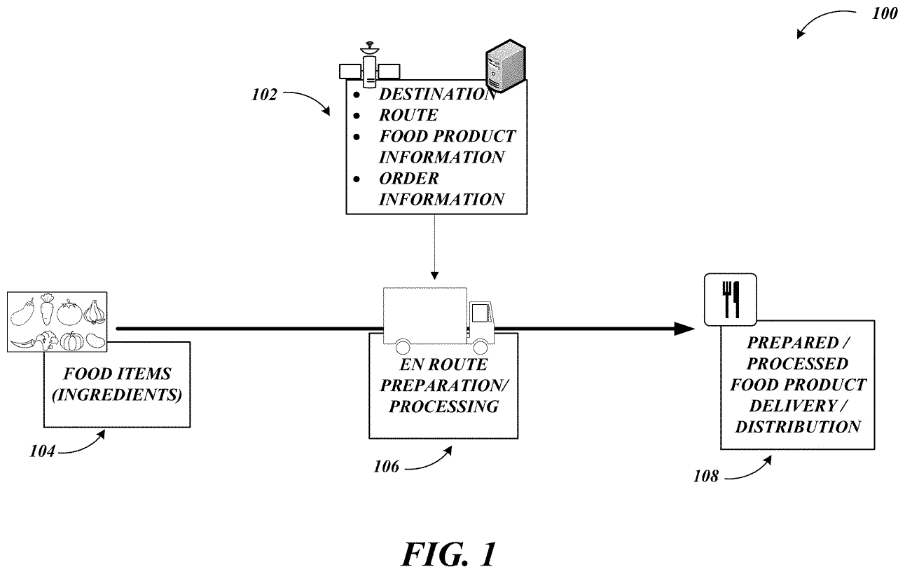

FIG. 1 includes a high-level block diagram for an example en route food preparation and delivery system, which may use vehicles with preparation and storage appliances, arranged in accordance with at least some embodiments described herein.

As shown in diagram 100, a delivery vehicle equipped for en route preparation may receive food items 104 (raw materials, ingredients, and similar items to be processed) and deliver prepared and/or processed food items 108 to a delivery destination. Prepared food items 108 may include configurable meal kits with food items in raw, cooked, semi-cooked, and other conditions. Fully cooked or baked food items, and or regulated consumables (e.g., tobacco, alcohol, cannabis products, and similar ones). En route preparation 106 may include a multi-step process, where operational parameters (e.g., temperature for heating or cooling a food item, water pressure for washing a food item, slicing or blending speeds, etc.) and timing of each step may be determined and/or adjusted based on travel route parameters such as road conditions, weather conditions, traffic congestion, expected arrival time, etc. Weather conditions may include one or more temperature, humidity, altitude, winds, wave size, etc. Road conditions may include one or more of road curvatures, road tilt (or expected vehicle tilt), construction, road roughness, etc.

A control system 102 may receive information associated with the ingredients and supplies (their quantity, quality, type, etc.), prepared food items (quantity, quality, type, packaging, etc.), and/or travel information. The control system 102 may determine operational parameters of the process steps and their timing based on the received information and instruct an autonomous food item preparation system in the delivery vehicle to perform the steps of the process based on the operational parameters and timing. The control system 102 may also send instructions for travel to the delivery vehicle (autonomous driving or for vehicle driver). The control system 102 may communicate through a remote controller with the delivery vehicle and its subs-systems. The delivery vehicle may include an on-board controller to manage operations of its sub-systems in coordination with the remote controller.

The autonomous food item preparation system in the delivery vehicle may include one or more food preparation and storage appliances arranged in one or more sealable container modules configured to feed each other. The delivery vehicle may include a truck, a railway car, and/or a watercraft or any other suitable vehicle. Alternatively, the autonomous food item preparation system may be installed in a container, which may be affixable to and transportable by one or more vehicles. In some cases, updated travel information such as addition of a new intermediate waypoint, elimination of an existing intermediate waypoint, change of the delivery destination, change of vehicle type or status, or selection of a different route may be received while en route. In response, operational parameters and timing of the steps of the process for food item preparation may be adjusted such that the food product is in a desired preparation state when the vehicle arrives at the destination.

In some implementations, the delivery vehicle may be a customized generic vehicle. For example, a generic shipping container may be customized to create a container capable of providing an environment for en route preparation of food items. The container may then be loaded onto or integrated into a vehicle such as a truck, a semi-truck, a railway car, an airplane, or a watercraft. In another example, a cargo area of a truck, a semi-truck, a railway car, or a watercraft may be customized to provide an environment for en route preparation of food items. The customization may include, but is not limited to, one or more intake ports to receive the ingredients and supplies, where a size or a position of the one or more intake ports may be re-configurable based on a type of the ingredients and supplies to be received. The customization may also include one or more delivery ports to provide a prepared food items, where a size or a position of the one or more delivery ports may be re-configurable based on a type of the food items to be delivered. The customization may further include one or more re-configurable anchor systems to anchor one or more food preparation and storage appliances, where the one or more re-configurable anchor systems may include a plurality of unitary anchor points or a plurality of separated anchor points along one or more interior walls, frames, or rails within the container/vehicle. The re-configurable anchor systems may include support extrusions and/or configurable mounting connectors as described herein. The customization may also include one or more re-configurable supply ports to supply the one or more food preparation and storage equipment, display devices on exterior walls to display advertising, branding information, or images of food preparation process from inside the vehicle.

In an example scenario, a meal kit delivery truck may receive ingredients at a food processing plant and receive instructions to deliver different types and amounts of meal kits to a number of destinations. A control system may determine possible travel routes for the delivery truck and suggest a selected route. The route may be selected based on fastest arrival or based on time needed to complete preparation (which may include preparation of the meal kits, par-cooking of some items in the meal kit, and/or fully cooking of other items in the meal kit). An order of delivery destinations may also be selected based on requested delivery time or based on preparation times needed for the different meal kits. For example, a delivery destination that requested meal kits with longest preparation time (e.g., some items requiring cooking) may be placed as the last destination, whereas a delivery destination that requested only meal kits with raw items may be selected as the first destination. Operational parameters and timing such as temperature of the ovens and refrigerators may be adjusted based on changing traffic conditions.

Operating conditions of the process step and/or food preparation equipment may be adjusted based upon the travel information and/or determined operating conditions of the vehicle. For example, the equipment parameters may be decreased, e.g., speed lowered, based upon determined (estimated or measured) travel information or vehicle parameters such as high vehicle sway or vibration. Similarly, process parameters including temperature, process (e.g., rising or cooking) time and or even ingredients may be adjusted based upon a determined environmental change of the travel information (e.g., altitude, temperature, humidity, etc.) change which may require different preparation parameters or even process. In some cases, equipment operational parameters may be dynamically adjusted based on determined (expected, predicted or measured) container or vehicle parameters based on travel information. For example, equipment may be placed in a closed operation status if vehicle parameters exceed some operational requirements (temperature, to reduce spillage, spoilage, equipment malfunction, etc.). In some cases, the selected food preparation equipment may be changed based on determined (expected, predicted or measured) container or vehicle parameters and travel information. For example, a closed system food preparation equipment (e.g., auger, agitator, plunger etc.) may be selected or adjusted for a processing step based on the travel information, as opposed to an open system food preparation equipment like a conveyor, mixer, etc. In some cases, the control system may pause food preparation at a waypoint stop or may increase food preparation or transfer at a waypoint stop (e.g., when the vehicle is being weighed at a weigh station, when the vehicle is being charged/fueled, or at an operator rest stop, etc.). In some cases, if the container temperature is too hot, equipment operations may be paused or adjusted to meet process requirements. Configuration of the preparation appliances in the delivery vehicle may be arranged based on the type of food items to be prepared and coordination of preparation steps. The appliances may be arranged to optimize the overall process, for example, picking of ingredients from storage, combination of various ingredients and processing in predefined orders. Thus, a vehicle equipped with a re-configurable anchor system such as support extrusions and configurable mounting connectors as described herein may allow optimal configuration and re-configuration of the preparation appliances.

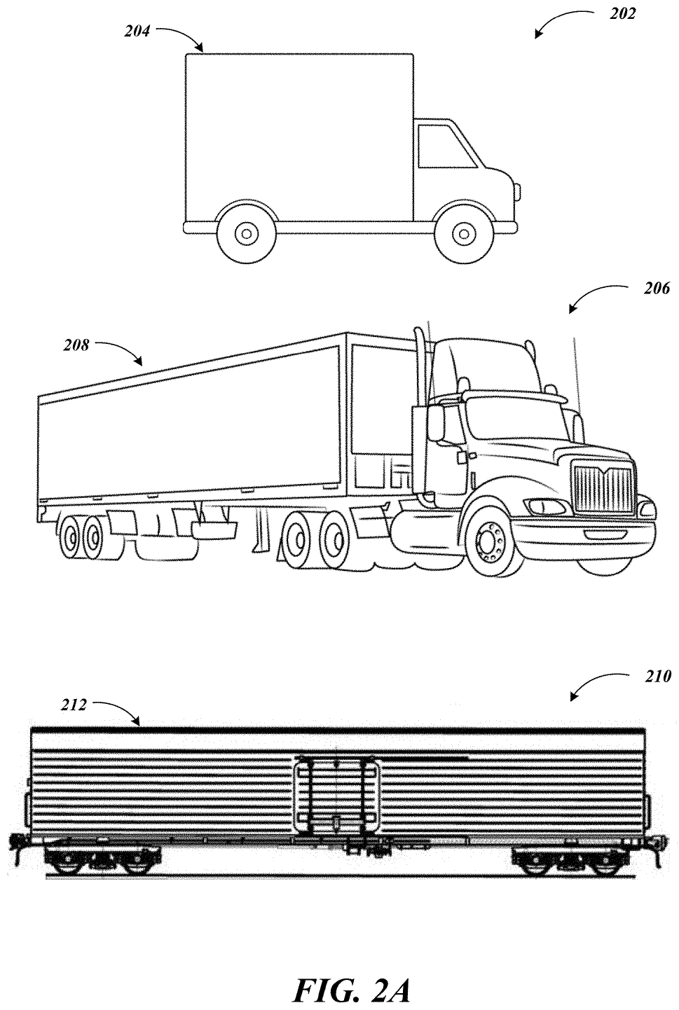

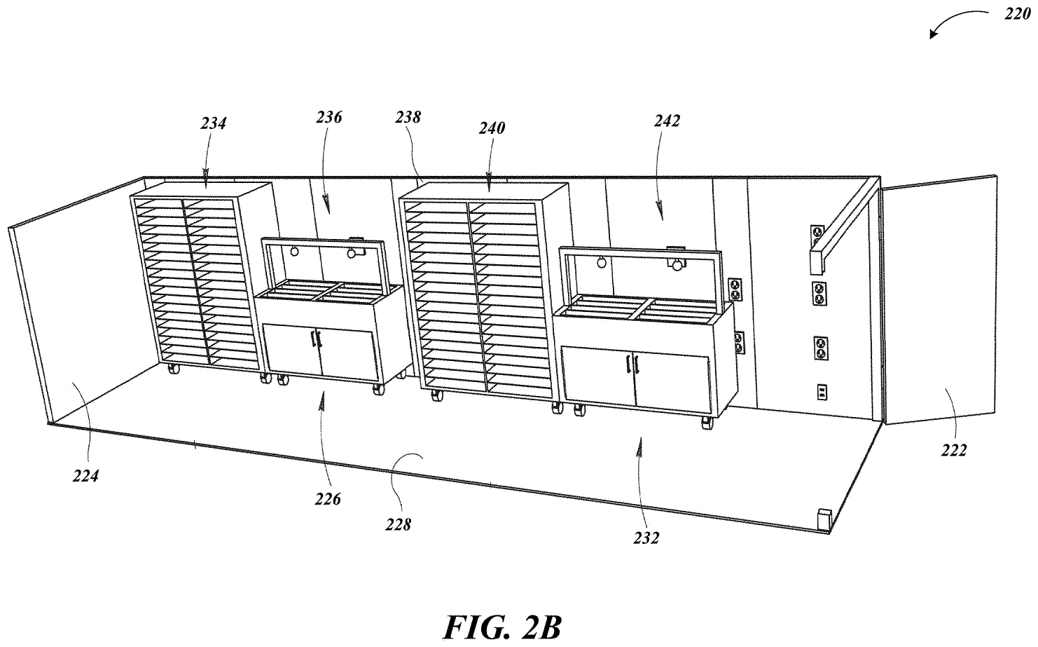

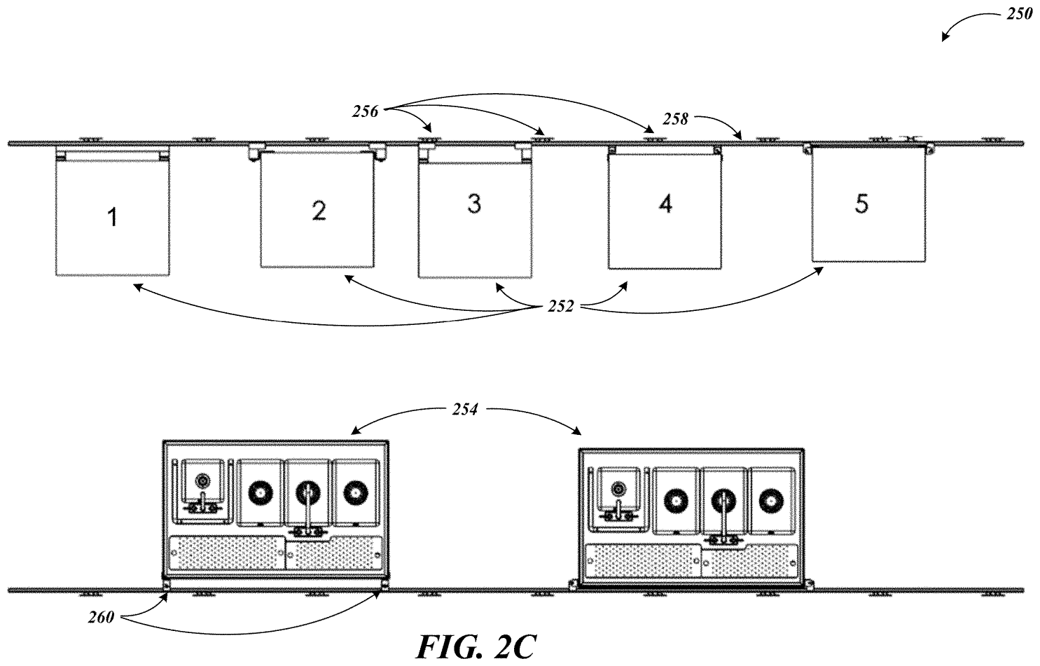

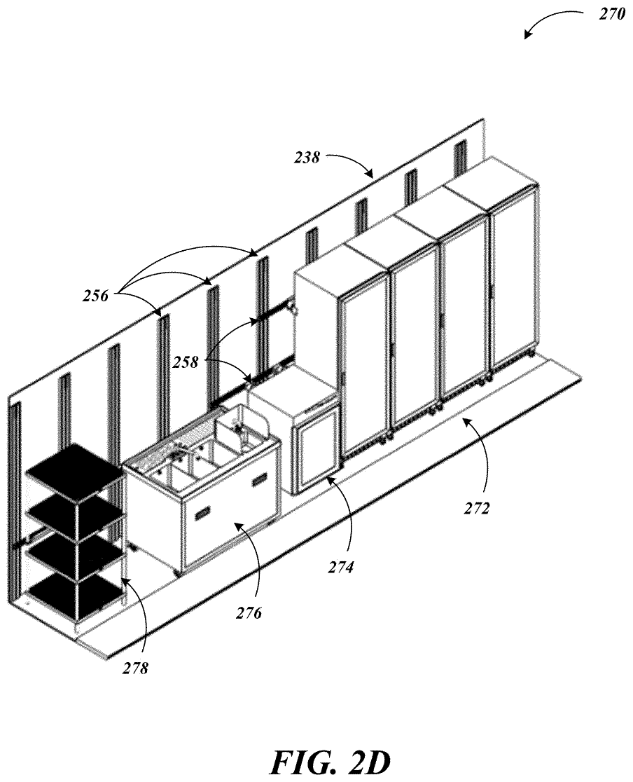

FIG. 2A includes examples of vehicles which may be used to process and deliver food items, arranged in accordance with at least some embodiments described herein.

Preparation, packaging, and storage of food items such as meal kits or fully cooked food products while en route for delivery may be performed in vehicles such as trucks, vans, railcars, watercraft, or aircraft. In addition to the listed vehicles and similar ones, food items may also be prepared, packaged, and stored in customized containers that may be fitted onto a truck, railcar, watercraft, or airplane. FIG. 2A shows some example vehicles that may be customized to provide an environment for the operations by placement of re-configurable appliances, equipment, and robotic devices for autonomous or semi-autonomous processing.

FIG. 2A includes truck 202, which may have a cargo portion 204 fitted with re-configurable appliances, equipment, and robotic devices for autonomous or semi-autonomous processing. Another example vehicle shown in FIG. 2A includes semi-truck 206 with its trailer 208. The trailer 208 may be a removable cargo container customized to provide an environment for the operations by placement of re-configurable appliances, equipment, and robotic devices for autonomous or semi-autonomous processing. The trailer 208 may also be a permanently affixed cargo portion customized similar to the cargo portion of the truck 202, but with larger space.

FIG. 2A also shows a railcar 210, which may include a cargo portion 212 permanently customized to provide an environment for the operations by placement of re-configurable appliances, equipment, and robotic devices for autonomous or semi-autonomous processing. In some examples, the cargo portion 212 may be a customized container loaded onto railcar 210, which may be a flatbed type railcar.

While example support extrusions and configurable mounting connectors are shown in example environments such as trucks, railcar containers, etc., embodiments are not limited to those environments. Support extrusions and configurable mounting connectors may also be used to attach appliances in a fixed environment such as a building. Furthermore, support extrusions and configurable mounting connectors according to example embodiments may be used to attach cabinets and appliances for other uses than food preparation and storage.

FIG. 2B includes an isometric interior view of an example container with a right-hand interior side wall cut away showing racks of heating and storage equipment as well as for processing appliances, arranged in accordance with at least some embodiments described herein.

In some embodiments, a food preparation container 220 may be dimensioned to slide into and fit inside a shell of a shipping container. The food preparation container 220 may include a pair of doors for access to the inside space. The food preparation container 220 may be configured to house autonomous food preparation equipment such that food items may be loaded into the container at a starting station and food products may be completed by the time the food preparation container reaches its destination. The food preparation container may have access ports as discussed above in conjunction with the delivery truck. Thus, in some cases, the dimensions of the food preparation container may be smaller than the shipping container acting as the outer shell.

In some alternative implementations, the food preparation container 220 may be configured and dimensioned to slide into and fit inside a semi-truck trailer, loaded onto a flatbed truck, a railway car, a watercraft, or similar vehicles. The food preparation equipment inside the container 220 may be configured in a modular fashion to provide a sterile environment for preparation of food items autonomously. As such, the food preparation container may include suitable control, power, communications, and computing equipment in addition to the food preparation equipment such as transport or processing robots, cooking devices, cooling devices, storage equipment, etc.

In the example configuration of food preparation container 220 shown in FIG. 2B, two racks 234, 240 of food preparation equipment are installed within the container 220 against the wall 238 on the floor 228. The two racks 234, 240 may have the same or similar features. The racks 234, 240 may house ovens, grills, coolers, storage drawers, or comparable equipment. Food items and supplies may be delivered into the container through the door 222 or other ports and doors that may be installed at suitable locations in suitable dimensions depending on the equipment configuration and food type(s).

Food preparation container 220 may further include ingredient/topping holders 226, 232. Similar to the racks 234, 240, the ingredient/topping holders 226, 232 may have the same or similar features. Depending on the contents, the ingredient/topping holders 226, 232 may have cooling/heating capability, or keep their contents at ambient temperature. Furthermore, dispensing robots 236, 242 may be arranged over the ingredient/topping holders 226, 232 to select, pick, and dispense contents of the ingredient/topping holders 226, 232 during food product preparation.

While specific types of equipment have been illustrated as being installed in the container 220, any food preparation equipment, such as any of the food preparation equipment described herein or food preparation equipment capable of performing any of the food processing or preparation procedures described herein, may be installed in the container 220. In some cases, the order in which the equipment is installed against the walls, front-to-back along the length of the container 220, may not be important, such as when each piece of food preparation equipment works independently, while in other cases, the order in which the equipment is installed, front-to-back along the length of the container 220, is important, such as when the products produced by one piece of food preparation equipment are used as an input by another piece of food preparation equipment.

Food preparation equipment may also be provided in any number of rows, such as one, two, three, four, or five rows extending along the length of the container 220. As another example, food preparation equipment may be provided in any number of layers, such as one, two, three, four, or five layers stacked vertically on top of one another. In general, the arrangement of the equipment within the interior space of the container 220 may be determined or driven by improvements to the overall efficiency of the food preparation system. In some implementations, the inner surfaces of the walls and doors may be made of various plastics or of stainless steel, brass, aluminum, or other oligodynamic materials. In some examples, container 220 may have no openings other than the door 222, that is, the container 220 may have no other doors, windows, or openings, and the door 222 may be closed to seal, such as hermetically seal, the interior of the container 220 from an external environment. In other implementations, the container 220 may have one or more segmented airlocks to control, allow, or prevent the flow of air between the interior of the container 220 and the external environment, and prevent or contain infestations. In some implementations, the container 220 may include one or more lighting systems, such as internal LED lighting systems, internal high-pressure sodium vapor lamp lighting systems, or skylights or windows to provide natural light to the interior of the container 220. In some cases, the interior of the container 220 may be provided with a combination of LED and natural lighting. In some implementations, mirrors, lenses, and/or other optical elements may be used to focus and/or direct light from its source(s) to location(s) where it is desired.

FIG. 2C includes a top plan view of an example vehicle with preparation and storage appliances attached to interior side walls of the vehicle through support extrusions and configurable mounting connectors, arranged in accordance with at least some embodiments described herein.

Vehicle 250 in FIG. 2C includes five example appliances 252 arranged against a side wall of the vehicle 250 and two preparation appliances 254 arranged against an opposing side wall of the vehicle 250. The appliances 252 may include storage racks, ovens, coolers, refrigerators, warmers, and a variety of processing equipment. Preparation appliances 254 may include washing stations, chopping stations, mixing stations, and other forms of preparation equipment. Some or all of the appliances may be equipped with robotic devices for semi-autonomous or autonomous preparation of the food items.

The appliances in the vehicle 250 may be attached to the side walls through a re-configurable anchor system. The re-configurable anchor system may include one or more frames composed of vertical and horizontal rails and mounting connectors that can be moved along the rails to configure and re-configure the appliances. In some examples, vertical support extrusions 256 may be affixed to the side wall in predefined separation distances. The support extrusions 256 may be equally spaced, randomly spaced, or arranged according to a predefined layout. The support extrusions 256 may extend between the ceiling and the floor of the vehicle 250 (or its cargo area) or along a subset of the ceiling-floor distance. Horizontal rails 258 may be affixed to the support extrusions along the side wall. The horizontal rails 258 may extend from a front wall to a back wall (or door in place of the front wall or back wall) or along a subset of the same distance. A number and separation of the horizontal rails 258 may be preselected based on vehicle specifications, appliance types to be used, etc. Horizontal rails 258 may include various shapes of tracks, channels, nut/bolt holes, and other mounting configurations for the appliances to be secured to the vehicle through mounting connectors or other mechanisms.

An example securing mechanism for the appliances may include configurable mounting connectors. Described in more detail below, such connectors may allow the appliances to be secured at selected locations to the horizontal rails 258. Depending on the design, configurable mounting connectors may allow appliances to be attached in a zero wall footprint configuration (i.e., with minimal space between two appliances), in an intrusion wall footprint configuration (i.e., with some space between two appliances, but closer to the sidewall), using vibration dampeners, or other arrangements. FIG. 2C also illustrates a variety of such arrangements. For example, Appliance 1 is shown with configurable mounting connectors in zero wall footprint configuration, Appliance 2 is shown with configurable mounting connectors in intrusion wall footprint configuration using dampeners, Appliance 3 is shown with configurable mounting connectors in zero wall footprint configuration using dampeners, Appliance 4 is shown with configurable mounting connectors in zero wall footprint configuration (no dampeners), and Appliance 1 is shown with configurable mounting connectors in intrusion wall footprint configuration (no dampeners).

As further discussed below, configurable mounting connectors may allow attachment of the appliances to the vehicle permanently, semi-permanently, or in a manually adjustable fashion, that is, an appliance may be moved and re-attached in a different configuration en route or when the vehicle is parked (as opposed to a manufacturing or vehicle service facility).

FIG. 2D includes an isometric interior view of an example vehicle with preparation and storage appliances attached to interior side walls of the vehicle through support extrusions and configurable mounting connectors, arranged in accordance with at least some embodiments described herein.

FIG. 2D shows racks 272, appliance 274, preparation appliance 276, and shelves 278 arranged against a side wall 238 of a delivery vehicle through vertical support extrusions 256 and horizontal rails 258. The racks 272 may be used for environmentally controlled (e.g., warm, hot, cold) storage of food items or include ovens, refrigerators, freezers, and other food processing equipment. Appliance 274 may be an oven, a refrigerator, a dishwasher, or similar device. Preparation appliance 276 may be a washing station, a chopping station, a topping holder, or similar. Shelves 278 may be used to store packaged food items, ingredients, packaging materials, or supplies. Due to the different nature of the appliances in the example configuration, different attachment methods may be applied. For example, racks 272 may be attached to the horizontal rails 258 using configurable mounting connectors in zero wall footprint configuration. Appliance 274 may be attached using configurable mounting connectors with dampeners to reduce vibration effects on the appliance from the vehicle while it is traveling. Preparation appliance 276 may be a freely movable appliance on wheels. Thus, it may be attached to the horizontal rails in a manually adjustable fashion.

Another example of flexibility of re-configurable anchor systems according to embodiments shown in FIG. 2D includes the configuration of the horizontal rails. Vertical support extrusions 256 are shown as extending from the floor of the vehicle (or its cargo area) to the ceiling in equal spacing. Horizontal rails 258 may, on the other hand, be arranged in predefined spacing and length between the front and back of the vehicle (or its cargo area). For example, the highest horizontal rail in the figure is shown to extend from the back to about halfway along the vehicle. The middle horizontal rail extends some more toward the front, and the lowest horizontal rail extends all the way from the back to the front. The different lengths of the horizontal rails may assign spaces for different types of appliances. Thus, the taller rack appliances, which may need attachment at multiple heights for stability may be attached toward the back of the vehicle. Shorter appliances or appliances that are not expected to carry heavy loads (e.g., shelves 278) may be arranged toward the front, where only the lowest (and/or the middle) horizontal rail is present.

Furthermore, side wall 238 of the vehicle (as well as other walls) may be equipped with various outlets and intake ports such as power, water, gas, pressured air outlets, waste water or air intake ports, etc. Such outlets and intake ports may be placed in accordance with the configuration of the horizontal rails (or vice versa) to allow pre-planning of appliance placement.

In addition to configurable mounting connectors, the horizontal rails 258 may be designed for permanent, semi-permanent, or manually adjustable attachment of the appliances. For example, a horizontal rail may include one or more channels and/or tracks with complementing channels or tracks on another rail piece attached to the back of an appliance. The appliance may be affixed to the vehicle by attaching the complementary rail piece to the horizontal rail (e.g., a snap-on attachment). Alternatively, the horizontal rail may include nut/bolt or screw holes in periodic spaces to allow the appliance to be affixed to the vehicle through nuts and bolts or screws. Whereas the latter option may be more of a permanent attachment, the snap-on type attachment may allow, in some examples, lateral movement of the appliance along the side wall 238. In yet other examples (such as configurable mounting connectors described herein), a pin or similar securing mechanism may allow attachment and detachment of the appliance from the horizontal rail manually. Thus, an appliance attached using a manually adjustable system may be removed or moved to a different configuration while the vehicle is en route or parked at a delivery destination without the need to have the re-configuration be performed at a manufacturing or service facility.

In an example scenario, a delivery truck may be configured to preparation and delivery of breakfast and snack foods (e.g., bagels, toasts, sandwiches, etc.) to one or more delivery destinations in the earlier parts of a day. Appliances in the cargo area of the truck may be arranged for optimal preparation and delivery of such foods. Then, in the afternoon, the truck may be re-configured for pizza delivery in the evening hours. This may be done simply by a driver or other personnel, while the truck is returning to a supply facility by detaching, reconfiguring, and re-attaching the appliances in a configuration optimal for pizza preparation and delivery. Thus, the same truck may be used for two different kinds of food item preparation and delivery on the same day without service personnel involvement.

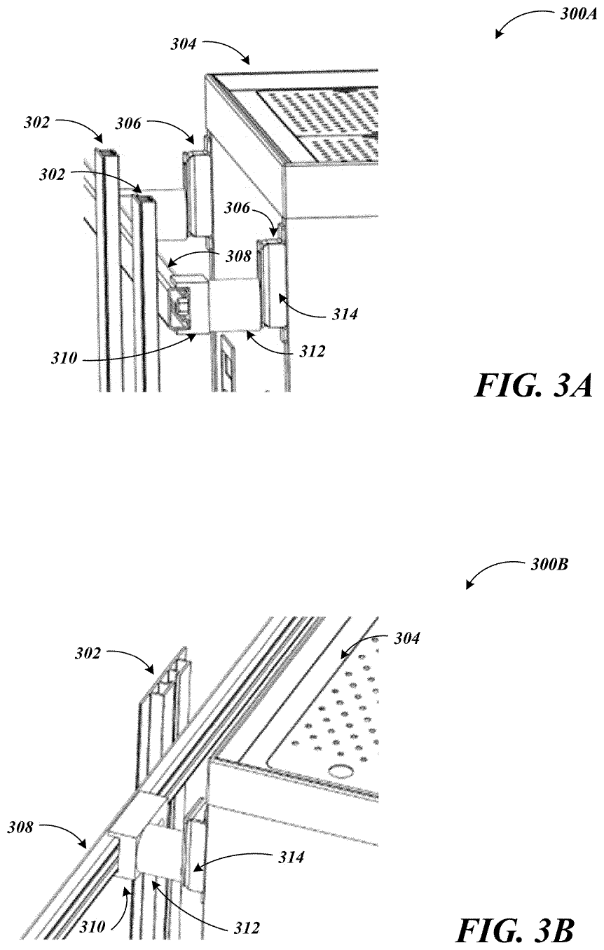

FIGS. 3A and 3B include cutaway views of a food preparation appliance attached to a support system through support extrusions and dampened mounting connectors from two perspectives, arranged in accordance with at least some embodiments described herein.

Diagram 300A shows a portion of an appliance 304 attached to a horizontal rail 308 through a pair of mounting connectors 306. The horizontal rail 308 is attached to a wall (e.g., interior side wall of a delivery vehicle) through a number of vertical extrusion supports 302 (two are shown in the figure). The mounting connectors 306 may include three components, a mounting block 310, a dampener 312, and an appliance connector 314. The appliance connector 314 may be affixed to the back of the appliance 304 through screws, nuts/bolts, a slide mechanism, welding, or other securing mechanisms.

The mounting block 310 may be affixed to the horizontal rail 308 through screws, nuts/bolts, or a snap-on or slide-on style connection using tracks and/or channels. The horizontal rail 308 may include one or more tracks or channels such as guide channels, telescopic tracks, hat channels, hook channels, and comparable ones, in some examples. The mounting block 310 may include a complementary structure that may fit through a snap-on or slide-on action onto the horizontal rail. In other examples, the mounting block may be affixed to the horizontal rail using a screw or nut/bolt pair in place of or in addition to the channel/track structure. Dampener 312 may be made from a solid elastic or semi-elastic material, or include a spring mechanism to allow reduction of vibrations transferred from the delivery vehicle to the appliance.

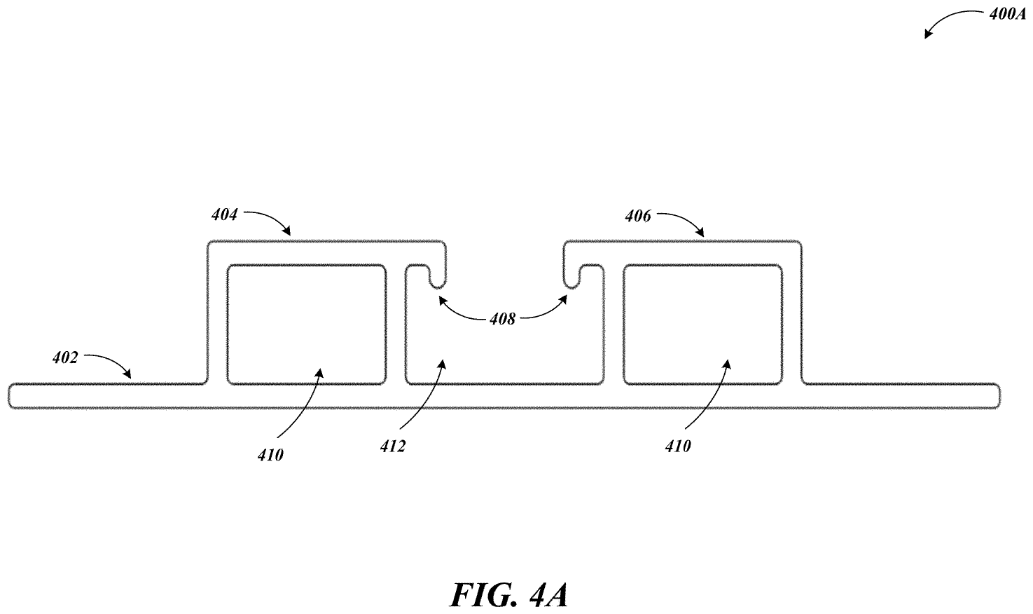

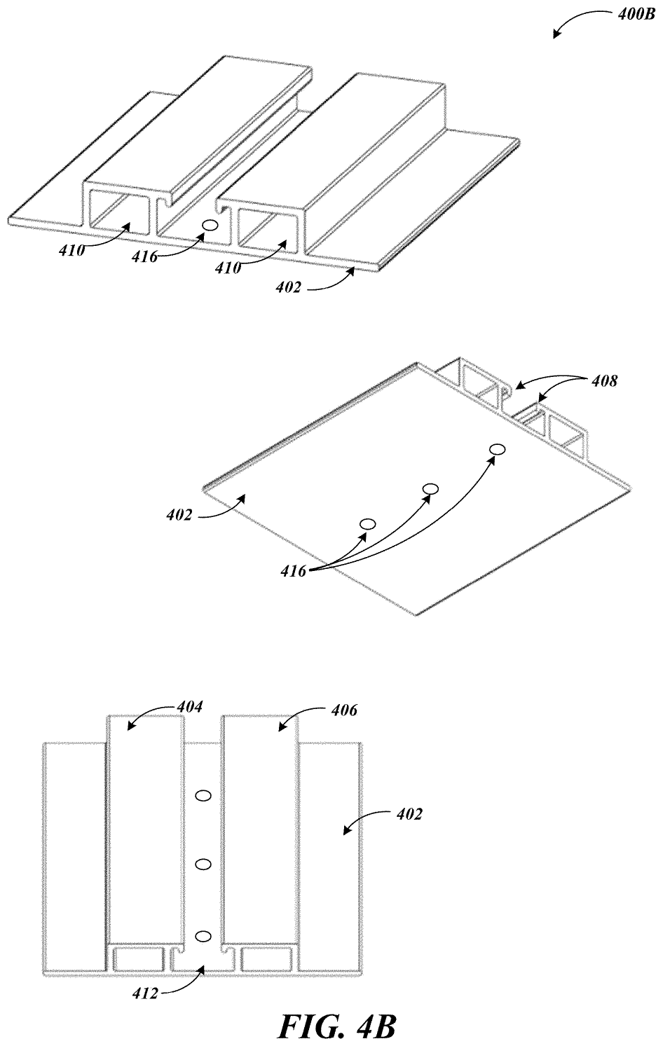

FIG. 4A includes a cross-sectional top view of a support extrusion and FIG. 4B includes various isometric views of a support extrusion from different perspectives, arranged in accordance with at least some embodiments described herein.

Diagram 400A shows an example support extrusion that includes a base plate 402, two enclosed channels 410 with respective support surfaces 404 and 406, and a center channel 412, where extensions from the support surfaces 404 and 406 form hooks 408 extending into the center channel 412. Thus, a cross section of the center channel 412 has a substantially “u” shape.

In some examples, the support extrusion may be attached to a wall of the vehicle using screws or nuts/bolts through holes 416 in the base plate at the bottom of the center channel. A horizontal rail may then be attached to the support extrusion through a snap-on or slide-on style mechanism in complementary shape to the center channel or using screws or nuts/bolts through holes on the support surfaces 404, 406. In other examples, the holes 416 in the base plate 402 may be used to attach both the horizontal rail and the support extrusion to the side wall.

The base plate having a broad profile may allow distribution of mechanical forces and provide increased stability. Enclosed channels 410 having empty centers may allow strong mechanical support while reducing a total weight of the support extrusion. In an example implementation, a width of the base plate 402 may be about 5 inches, a distance between the outer walls of the enclosed channels may be about 3 inches, and a height (from the base plate to the support surfaces) of the enclosed channels may be about 0.7 inches. The dual enclosed channels may allow shorter height without reduced strength, thereby reducing wasted space in the cargo area of the vehicle (appliances can be arranged closer to the walls of the cargo area). The dimensions provided above are for illustration purposes and do not indicate a limitation on embodiments.

Views of the support extrusions from different perspectives in FIG. 3B illustrate holes 416. Dimensions of the holes and distances between the holes may be periodic, random, or according to a pre-defined scale base on expected connections (appliance sizes, weights to be supported, etc.). The support extrusion may be composed from metal such as aluminum, steel, alloys, etc. The support extrusion may also be composed from composite materials, ceramic, or similar materials.

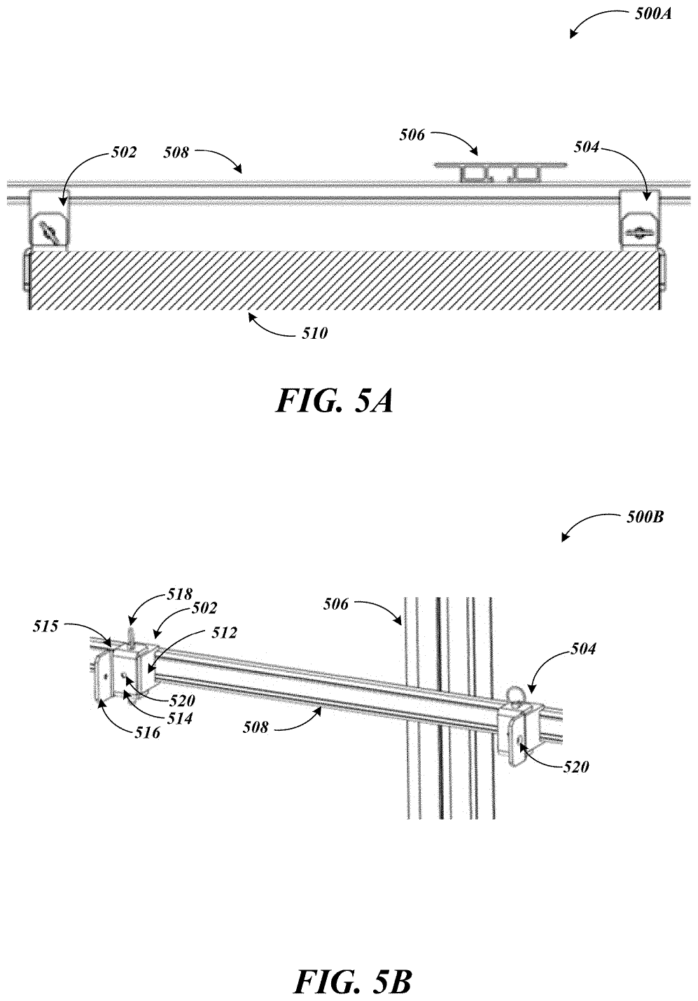

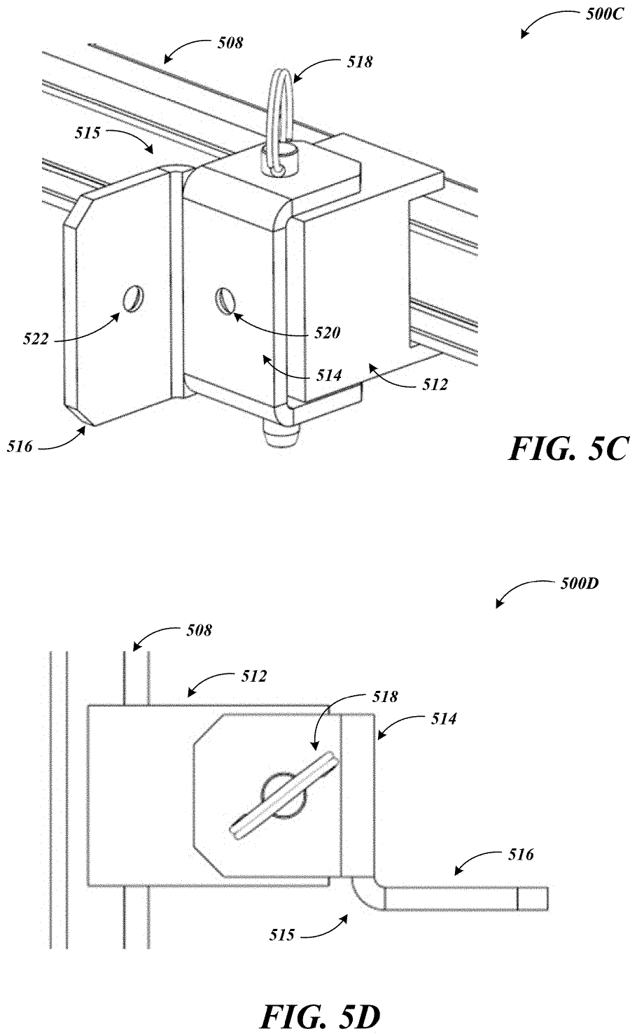

FIG. 5A includes a top view of a pair of configurable mounting connectors attached to an appliance in a zero wall footprint configuration, which allows appliances to be placed without spacing between each appliance, arranged in accordance with at least some embodiments described herein.

Diagram 500A shows back portion of an appliance 510 attached to a horizontal rail 508 through a pair of configurable mounting connectors 502, 504. The horizontal rail 508 is attached to a support extrusion 506 on a wall of the delivery vehicle. The configurable mounting connectors 502, 504 are in the zero wall footprint configuration that allows appliances to be arranged with little or no space between each other. While the top view in diagram 500A shows one pair of configurable mounting connectors 502, 504 securing the appliance 510, appliances may be secured to the horizontal rail 508 through multiple pairs of configurable mounting connectors at various heights depending on a height and weight of the appliance for stability.

FIG. 5B includes an isometric view of the pair of configurable mounting connectors of FIG. 5A in the zero wall footprint configuration, arranged in accordance with at least some embodiments described herein.

Diagram 500B shows the configurable mounting connectors 502, 504 without the appliance. Each mounting connector includes a mounting block 512, a right-angle connection plate 515, and a security pin 518. The right-angle connection plate 515 may include an appliance portion 516 and a mounting block portion 514 at a substantially 90-degree angle to the appliance portion. The mounting block portion 514 may have a u-shape that envelopes the mounting block 512 vertically and may be affixed to the mounting block through the security pin 518. The mounting block 512 may have a hole passing through the mounting hole vertically. Similarly, the top and bottom parts of the mounting block portion 514 may include matching holes. The security pin 518 may pass through the holes holding the mounting block portion 514 and the mounting block 512 together. The mounting block 512 may also include a second hole that passes through the body of the mounting block horizontally allowing the mounting block 512 to be secured to the horizontal rail through a screw or nut/bolt combination. The mounting block portion 514 and the appliance portion 516 may include substantially centered holes for attachment of the appliance through a screw or nut/bolt combination. As discussed above, the mounting block 512 may also be secured to the horizontal rail 508 through a complementary channel and/or track structure.

FIG. 5C includes an isometric close-up view of a configurable mounting connector in the zero wall footprint configuration, arranged in accordance with at least some embodiments described herein.

Diagram 500C shows a configurable mounting connector with a mounting block 512, a right-angle connection plate 515, and a security pin 518. The right-angle connection plate 515 includes an appliance portion 516 and a mounting block portion 514 at a substantially 90-degree angle to the appliance portion. The mounting block portion 514 has a u-shape that envelopes the mounting block 512 vertically and may be affixed to the mounting block through the security pin 518. The mounting block 512 may have a hole passing through the mounting hole vertically. Similarly, the top and bottom parts of the mounting block portion 514 may include matching holes. The security pin 518 may pass through the holes holding the mounting block portion 514 and the mounting block 512 together. The mounting block 512 may also include a second hole that passes through the body of the mounting block horizontally allowing the mounting block 512 to be secured to the horizontal rail 508 through a screw or nut/bolt combination in addition to or in place of a complementary channel and/or track structure. The mounting block portion 514 and the appliance portion 516 may include substantially centered holes 520 and 522 for attachment of the appliance through a screw or nut/bolt combination.

In the zero wall footprint configuration, the appliance portion 516 of the right-angle connection plate 515 is at substantially 90 degrees to the horizontal rail 508 (and thereby to the wall). Thus, the appliance portion 516 may be affixed to a side of the appliance. This may allow two appliances to be arranged side-by-side with minimal space between each other (e.g., thickness of the appliance portions). The zero wall footprint configuration may also result in some spacing between the horizontal rail and the back of the appliance (e.g., a thickness of the mounting block portion and a depth of the mounting block).

The shape of the right-angle connection plate 515 and the security pin mechanism allows the configuration of the configurable mounting connector to be manually changed. For example, the security pin 518 may be removed (manually), the right-angle connection plate 515 rotated horizontally clockwise by about 90 degrees, and the security pin placed back in. This would change the configuration to intrusion wall footprint configuration with the appliance to be mounted to the left of the configurable mounting connector.

FIG. 5D includes a top close-up view of the configurable mounting connector in the zero wall footprint configuration, arranged in accordance with at least some embodiments described herein.

The right-angle connection plate 515 of the configurable mounting connector may be composed from metal such as aluminum, steel, alloys, etc. The right-angle connection plate 515 may also be composed from composite materials, ceramic, or similar materials. The mounting block 512 may be composed same or similar materials as the right-angle connection plate 515. In other examples, the mounting block 512 may be composed of elastic or semi-elastic materials and act as dampener in addition to securing the appliance to the horizontal rail.

Dimensions of the right-angle connection plate 515 and the mounting block 512 may be selected based on appliance types (e.g., expected weight and height), horizontal rail dimensions, and mounting connector materials. In some cases, the components may have standardized sizes. In other examples, they may have custom dimensions.

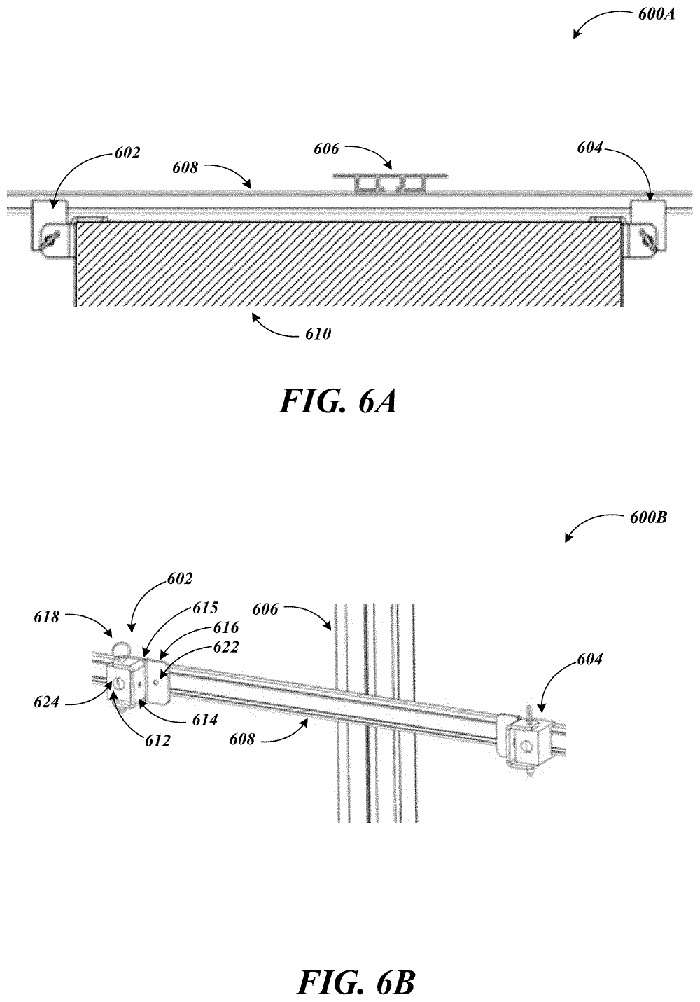

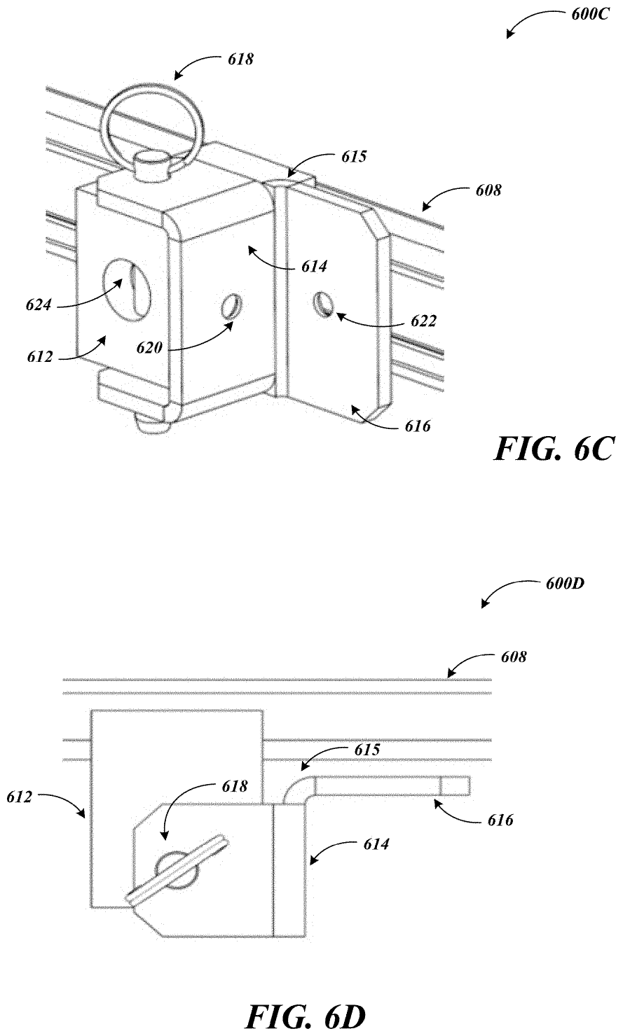

FIG. 6A includes a top view of a pair of configurable mounting connectors attached to an appliance in an intrusion wall footprint configuration, which allows appliances to be placed with spacing between each appliance but closer to a wall, arranged in accordance with at least some embodiments described herein.

Diagram 600A shows back portion of an appliance 610 attached to a horizontal rail 608 through a pair of configurable mounting connectors 602, 604 in intrusion wall footprint configuration. The horizontal rail 608 is attached to a support extrusion 606 on a wall of the delivery vehicle. The configurable mounting connectors 602, 604 are in the intrusion wall footprint configuration that allows appliances to be arranged with little or no space between the appliance and the horizontal rail. While the top view in diagram 600A shows one pair of configurable mounting connectors 602, 604 securing the appliance 610, appliances may be secured to the horizontal rail 608 through multiple pairs of configurable mounting connectors at various heights depending on a height and weight of the appliance for stability.

FIG. 6B includes an isometric view of the pair of configurable mounting connectors of FIG. 6A in the intrusion wall footprint configuration, arranged in accordance with at least some embodiments described herein.

Diagram 600B shows the configurable mounting connectors 602, 604 without the appliance. Each mounting connector includes a mounting block 612, a right-angle connection plate 615, and a security pin 618. The right-angle connection plate 615 may include an appliance portion 616 and a mounting block portion 614 at a substantially 90-degree angle to the appliance portion. The mounting block portion 614 may have a u-shape that envelopes the mounting block 612 vertically and may be affixed to the mounting block through the security pin 618. The mounting block 612 may have a hole passing through the mounting hole vertically. Similarly, the top and bottom parts of the mounting block portion 614 may include matching holes. The security pin 618 may pass through the holes holding the mounting block portion 614 and the mounting block 612 together. The mounting block 612 may also include a second hole 624 that passes through the body of the mounting block horizontally allowing the mounting block 612 to be secured to the horizontal rail through a screw or nut/bolt combination in addition to or in place of a complementary channel and/or track structure. The mounting block portion 614 and the appliance portion 616 may include substantially centered holes (e.g., right-angle connection plate hole 622) for attachment of the appliance through a screw or nut/bolt combination.

FIGS. 6C and 6D include an isometric close-up view and a top close-up of a configurable mounting connector in the intrusion wall footprint configuration, arranged in accordance with at least some embodiments described herein.

Diagram 600C shows a configurable mounting connector with a mounting block 612, a right-angle connection plate 615, and a security pin 618 in the intrusion wall footprint configuration. The right-angle connection plate 615 includes an appliance portion 616 and a mounting block portion 614 at a substantially 90-degree angle to the appliance portion. The mounting block portion 614 has a u-shape that envelopes the mounting block 612 vertically and may be affixed to the mounting block through the security pin 618. The mounting block 612 may have a hole passing through the mounting hole vertically. Similarly, the top and bottom parts of the mounting block portion 614 may include matching holes. The security pin 618 may pass through the holes holding the mounting block portion 614 and the mounting block 612 together. The mounting block 612 may also include a second hole 624 that passes through the body of the mounting block horizontally allowing the mounting block 612 to be secured to the horizontal rail 608 through a screw or nut/bolt combination. The mounting block portion 614 and the appliance portion 616 may include substantially centered holes 620 and 622 for attachment of the appliance through a screw or nut/bolt combination.

In the intrusion wall footprint configuration, the appliance portion 616 of the right-angle connection plate 615 is substantially parallel to the horizontal rail 608 (and thereby to the wall). Thus, the appliance portion 616 may be affixed to the back of the appliance. This may allow the appliances to be arranged with minimal spacing to the horizontal rail (e.g., thickness of the appliance portion). In the intrusion wall footprint configuration spacing between the appliances may be larger than the zero wall footprint configuration (e.g., a width of the mounting block and a thickness of the mounting block portion).

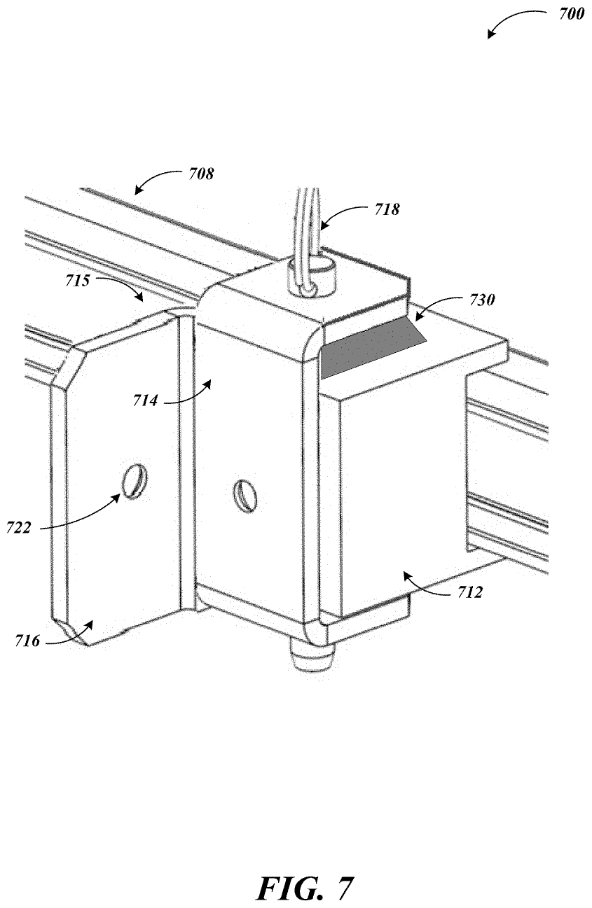

FIG. 7 includes an isometric close-up view of a configurable mounting connector in the zero wall footprint configuration with a vibration dampening element, arranged in accordance with at least some embodiments described herein.

As discussed above, a mounting block of a configurable mounting connector may be made from elastic or semi-elastic materials in some examples providing dampening characteristics. In other examples, a dampener may be added to the mounting connector assembly.

Diagram 700 shows a configurable mounting connector with a mounting block 712, a right-angle connection plate 715, and a security pin 718. The right-angle connection plate 715 includes an appliance portion 716 and a mounting block portion 714 at a substantially 90-degree angle to the appliance portion. The mounting block portion 714 has a u-shape that envelopes the mounting block 712 vertically and may be affixed to the mounting block through the security pin 718. The mounting block portion 714 and the appliance portion 716 may include substantially centered holes 720 and 722 for attachment of the appliance through a screw or nut/bolt combination. In addition to the features similar to those shown in FIGS. 5C and 6C, the configurable mounting connector in FIG. 7 includes dampener 730 placed between a top part of the mounting block portion 714 and the mounting block 712. In some examples, a second dampener (not shown) may also be placed between a bottom part of the mounting block portion 714 and the mounting block 712. The dampener 730 may be made from elastic or semi-elastic materials and reduce vibration transmitted by the vehicle to the appliance by interrupting the vibration between the mounting block 712 and the right-angle connection plate 715.

According to some examples, a re-configurable anchor system for en route food item preparation vehicles is described. The anchor system may include one or more frames that include a plurality of vertical support extrusions and a plurality of horizontal rails, where the plurality of vertical support extrusions are affixed to an interior wall of the vehicle and the plurality of horizontal rails are affixed to the plurality of vertical support extrusions; and a plurality of configurable mounting connectors. Each appliance may be attached to one or more of the plurality of horizontal rails through one or more pairs of configurable mounting connectors. The plurality of configurable mounting connectors may be configured to secure an appliance in a first configuration that allows reduced spacing between appliances or in a second configuration that allows reduced spacing between the appliance and the interior wall.

According to other examples, the plurality of configurable mounting connectors may be manually reconfigurable between the first configuration and the second configuration. A number and a separation distance of the plurality of vertical support extrusions affixed to the interior wall may be selected based on one or more of a size of the vehicle, a size of the appliances, a type of the appliances, or an expected weight of the appliances. A number, a length, and a separation distance of the plurality of horizontal rails may be selected based on one or more of a size of the vehicle, a size of the appliances, a type of the appliances, a grouping of the appliances, or an expected weight of the appliances.

According to further examples, the plurality of horizontal rails may be affixed to the plurality of vertical support extrusions through one or more of a complementary track system, a complementary channel system, a screw coupling, or a nut/bolt coupling. The plurality of vertical support extrusions may be affixed to the interior wall of the vehicle and the plurality of horizontal rails are affixed to the plurality of vertical support extrusions permanently, semi-permanently, or in a manually adjustable fashion. The plurality of configurable mounting connectors may be manually reconfigurable such that the appliances in the vehicle are rearrangeable between one type of food items preparation and delivery and another type of food items preparation and delivery. Each support extrusion may include a base plate and a substantially “u” shaped center channel formed by two enclosed channels on a surface of the base plate, wherein the enclosed channels have a substantially rectangular cross section.

According to other examples, a configurable mounting connector may include a mounting block configured to attach to a horizontal rail of an anchor system and a right-angle connection plate removably attached to the mounting block. The right-angle connection plate may include an appliance portion with a hole for attachment to an appliance and a mounting block portion that includes a top part, a middle part, and a bottom part. The middle part may e attached to the appliance portion at a substantially right-angle, and the mounting block portion may be substantially “u” shaped such that the top part is aligned with a top surface of the mounting block and the bottom part is aligned with a bottom surface of the mounting block.

According to some examples, the right-angle connection plate may be removably attached to the mounting block through a security pin inserted through aligned holes in the top part and the bottom part of the mounting block portion and the mounting block. The mounting block may be configured to attach to the horizontal rail through one or more of a complementary track system, a complementary channel system, a screw coupling, or a nut/bolt coupling. The mounting block may include a hole for the screw coupling or the nut/bolt coupling transversally arranged to a security pin hole within the mounting block. The middle part of the mounting block portion and the appliance portion may include respective holes for attachment to the appliance through a screw coupling or a nut/bolt coupling.

According to other examples, the configurable mounting connector may include a dampener positioned between the top part of the mounting block portion and the top surface of the mounting block and/or between the bottom part of the mounting block portion and the bottom surface of the mounting block. The mounting block and the right-angle connection plate may be composed of a metal, a metal alloy, a ceramic, or a composite material, and the dampener may be composed of an elastic material, a semi-elastic material, or a spring. In a first configuration that allows reduced spacing between appliances, the appliance portion of the right-angle connection plate may be attached to a side of the appliance, and in a second configuration that allows reduced spacing between the appliance and the horizontal rail, the appliance portion of the right-angle connection plate may be attached to a back of the appliance.

According to further examples, a method for arranging appliances in an en route food item preparation vehicle is described. The method may include attaching a first pair of configurable mounting connectors to a horizontal rail of a re-configurable anchor system of the vehicle, where each configurable mounting connector include a mounting portion attachable to the horizontal rail through one or more of a complementary track system, a complementary channel system, a screw coupling, or a nut/bolt coupling, and a right-angle connection plate removably attached to the mounting block. The method may also include attaching right-angle connection plates of the first pair of configurable mounting connectors to respective sides of a first appliance to arrange the first appliance in a first configuration that allows reduced spacing between appliances; attaching a second pair of configurable mounting connectors to the horizontal rail of the re-configurable anchor system of the vehicle; and attaching right-angle connection plates of the second pair of configurable mounting connectors to a back of the second appliance to arrange the second appliance in a second configuration that allows reduced spacing between the second appliance and the horizontal rail.

According to some examples, the method may further include removing security pins of the second pair of configurable mounting connectors and rotating the right-angle connection plates of the second pair of configurable mounting connectors to change the second pair of configurable mounting connectors from the first configuration to the second configuration prior to attaching the right-angle connection plates of the second pair of configurable mounting connectors to the back of the second appliance. The method may also include selecting the horizontal rail among a plurality of horizontal rails and a location on the horizontal rail to attach the first and second pair of configurable mounting connectors based on a size, a type, or an expected weight of the first and second appliances. The method may further include positioning a dampener between a top part of a mounting block portion of each right-angle connection plate and a top surface of respective mounting blocks and/or between a bottom part of the mounting block portion and a bottom surface of the respective mounting blocks.

Certain specific details are set forth herein in order to provide a thorough understanding of various disclosed embodiments. However, one skilled in the relevant art will recognize that embodiments may be practiced without one or more of these specific details, or with other methods, components, materials, etc. In other instances, certain structures associated with food preparation devices such as ovens, skillets, and other similar devices, closed-loop controllers used to control cooking conditions, food preparation techniques, wired and wireless communications protocols, wired and wireless transceivers, radios, communications ports, geolocation, and optimized route mapping algorithms have not been shown or described in detail to avoid unnecessarily obscuring descriptions of the embodiments. In other instances, certain structures associated with conveyors, robots, and/or vehicles have not been shown or described in detail to avoid unnecessarily obscuring descriptions of the embodiments.

As used herein the term “travel information” refers to delivery destination locations, one or more potential routes between the delivery destinations, road condition information (road curvatures, road tilt, expected vehicle tilt, construction, road roughness, etc.) for the potential routes, traffic condition information for the potential routes, weather condition information (temperature, humidity, altitude, winds, wave size, etc.) for the potential routes, licensing information, and any other conditions that may affect travel of the vehicle equipped to prepare food items en route.

As used herein the terms “food item” and “food product” refer to any item or product intended for human consumption. A “food product” is generally understood to be made by preparing “food items”, that is, ingredients, raw or cooked materials, etc., and may also include interim ingredients (e.g., prepared ingredients that may be used to prepare a final food product, e.g., pizza sauce). Although illustrated and described in some embodiments herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food items or products, including cooked and uncooked food items or products, and ingredients or components of food items and products. The term “meal kit” refers to a set of foods and ingredients for making a meal for human consumption. The foods and ingredients of the meal kit may be raw, partially cooked, and/or fully cooked.

As used herein the terms “robot” or “robotic” refer to any device, system, or combination of systems and devices that includes at least one appendage, typically with an end of arm tool or end effector, where the at least one appendage is selectively moveable to perform work or an operation useful in the preparation a food item or packaging of a food item or food product. The robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator. Alternatively, one or more robots can be partially remotely controlled by a human operator and partially autonomously controlled.

As used herein, the term “food preparation equipment” refers to any equipment or appliance used prepare “food items” including “cooking”, but not limited to. For example, “food preparation equipment” may be used to slice, dice, blend, wash, or otherwise process the “food items”. For example, food preparation equipment refers to any device, system, or combination of systems and devices useful in the preparation of a food product. While such preparation may include ingredient distribution devices, choppers, peeler, cooking units for the heating of food products during preparation, rolling units, mixers, blenders, etc. and such preparation may also include the partial or complete cooling of one or more food products. Further, the food preparation equipment may be able to control more than temperature. For example, some food preparation equipment may control pressure or humidity. Further, some food preparation equipment may control airflow therein, thus able to operate in a convective mode if desired, for instance to decrease preparation time.

As used herein, food preparation refers to any preparation or process of food items to prepare a food product from that food item and may include any one or more of washing, destemming, peeling, mixing, chopping, blending, grinding, cooking, cooling, and packaging, and the time, temperature speed or any other control or environmental factor of that processing step.

As used herein the term “thermal pack” refers to a package of thermal transfer medium that can transfer heat to or absorb heat to maintain a desired temperature within a packing box of a meal kit. Thermal transfer medium of a thermal pack can be passive but could be active. Passive thermal transfer medium may include water, gel, ethylene glycol, glycerol, or the like. Active thermal transfer medium may include one or more materials that produce heat or cold via a chemical reaction, e.g., iron powder, sodium acetate, or the like.

As used herein the term “insulated” or “thermally insulated” means a space, e.g., a box, a cell of a box, etc., is surrounded by materials that form barriers for the heat exchanging between the space and the environment outside of the space. The materials used for insulating a space in the embodiments disclosed herein have a thermal conductivity less than 1 Watt per meter-Kelvin (W/mk), such material include Polyethylene Terephthalate (PET) fiber/powder, Polypropylene (PP) fiber/power, still air, vacuumed space, etc. The materials used for insulating the space may keep the space under a predetermined temperature, e.g., 4° C., for at least a period of time, e.g., 30 minutes. The term “not insulated” or “not thermally insulated” means a space is not surrounded by materials that have a thermal conductivity less than 1 Watt per meter-Kelvin (W/mk). As used herein the term “vehicle” refers to any car, truck, van, train, watercraft, or other vehicle useful in preparing a food item during a delivery process.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

A processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A re-configurable anchor system for en route food item preparation vehicles, the anchor system comprising:
one or more frames comprising a plurality of vertical support extrusions and a plurality of horizontal rails, wherein the plurality of vertical support extrusions are affixed to an interior wall of the vehicle and the plurality of horizontal rails are affixed to the plurality of vertical support extrusions; and
a plurality of configurable mounting connectors, wherein
each appliance is attached to one or more of the plurality of horizontal rails through one or more pairs of configurable mounting connectors, and
the plurality of configurable mounting connectors are configured to secure an appliance in a first configuration that allows reduced spacing between appliances or in a second configuration that allows reduced spacing between the appliance and the interior wall.

2. The anchor system of claim 1, wherein the plurality of configurable mounting connectors are manually reconfigurable between the first configuration and the second configuration.

3. The anchor system of claim 1, wherein a number and a separation distance of the plurality of vertical support extrusions affixed to the interior wall are selected based on one or more of a size of the vehicle, a size of the appliances, a type of the appliances, or an expected weight of the appliances.

4. The anchor system of claim 1, wherein a number, a length, and a separation distance of the plurality of horizontal rails are selected based on one or more of a size of the vehicle, a size of the appliances, a type of the appliances, a grouping of the appliances, or an expected weight of the appliances.

5. The anchor system of claim 1, wherein the plurality of horizontal rails are affixed to the plurality of vertical support extrusions through one or more of a complementary track system, a complementary channel system, a screw coupling, or a nut/bolt coupling.

6. The anchor system of claim 1, wherein the plurality of vertical support extrusions are affixed to the interior wall of the vehicle and the plurality of horizontal rails are affixed to the plurality of vertical support extrusions permanently, semi-permanently, or in a manually adjustable fashion.

7. The anchor system of claim 1, wherein the plurality of configurable mounting connectors are manually reconfigurable such that the appliances in the vehicle are rearrangeable between one type of food items preparation and delivery and another type of food items preparation and delivery.

8. The anchor system of claim 1, wherein each support extrusion comprises a base plate and a substantially “u” shaped center channel formed by two enclosed channels on a surface of the base plate, wherein the enclosed channels have a substantially rectangular cross section.

9. A configurable mounting connector comprising:
a mounting block configured to attach to a horizontal rail of an anchor system; and
a right-angle connection plate removably attached to the mounting block, wherein the right-angle connection plate comprises:
an appliance portion with a hole for attachment to an appliance; and
a mounting block portion comprising a top part, a middle part, and a bottom part, wherein
the middle part is attached to the appliance portion at a substantially right-angle, and
the mounting block portion is substantially “u” shaped such that the top part is aligned with a top surface of the mounting block and the bottom part is aligned with a bottom surface of the mounting block.

10. The configurable mounting connector of claim 9, wherein the right-angle connection plate is removably attached to the mounting block through a security pin inserted through aligned holes in the top part and the bottom part of the mounting block portion and the mounting block.

11. The configurable mounting connector of claim 9, wherein the mounting block is configured to attach to the horizontal rail through one or more of a complementary track system, a complementary channel system, a screw coupling, or a nut/bolt coupling.

12. The configurable mounting connector of claim 11, wherein the mounting block comprises a hole for the screw coupling or the nut/bolt coupling transversally arranged to a security pin hole within the mounting block.

13. The configurable mounting connector of claim 9, wherein the middle part of the mounting block portion and the appliance portion include respective holes for attachment to the appliance through a screw coupling or a nut/bolt coupling.

14. The configurable mounting connector of claim 9, further comprising a dampener positioned between the top part of the mounting block portion and the top surface of the mounting block and/or between the bottom part of the mounting block portion and the bottom surface of the mounting block.

15. The configurable mounting connector of claim 14, wherein
the mounting block and the right-angle connection plate are composed of a metal, a metal alloy, a ceramic, or a composite material, and
the dampener is composed of an elastic material, a semi-elastic material, or a spring.

16. The configurable mounting connector of claim 9, wherein
in a first configuration that allows reduced spacing between appliances, the appliance portion of the right-angle connection plate is attached to a side of the appliance, and
in a second configuration that allows reduced spacing between the appliance and the horizontal rail, the appliance portion of the right-angle connection plate is attached to a back of the appliance.

17. A method for arranging appliances in an en route food item preparation vehicle, the method comprising:
attaching a first pair of configurable mounting connectors to a horizontal rail of a re-configurable anchor system of the vehicle, wherein each configurable mounting connector comprises:
a mounting portion attachable to the horizontal rail through one or more of a complementary track system, a complementary channel system, a screw coupling, or a nut/bolt coupling, and
a right-angle connection plate removably attached to the mounting block;
attaching right-angle connection plates of the first pair of configurable mounting connectors to respective sides of a first appliance to arrange the first appliance in a first configuration that allows reduced spacing between appliances;
attaching a second pair of configurable mounting connectors to the horizontal rail of the re-configurable anchor system of the vehicle; and
attaching right-angle connection plates of the second pair of configurable mounting connectors to a back of the second appliance to arrange the second appliance in a second configuration that allows reduced spacing between the second appliance and the horizontal rail.

18. The method of claim 17, further comprising:
prior to attaching the right-angle connection plates of the second pair of configurable mounting connectors to the back of the second appliance, removing security pins of the second pair of configurable mounting connectors and rotating the right-angle connection plates of the second pair of configurable mounting connectors to change the second pair of configurable mounting connectors from the first configuration to the second configuration.

19. The method of claim 17, further comprising:
selecting the horizontal rail among a plurality of horizontal rails and a location on the horizontal rail to attach the first and second pair of configurable mounting connectors based on a size, a type, or an expected weight of the first and second appliances.

20. The method of claim 17, further comprising:
positioning a dampener between a top part of a mounting block portion of each right-angle connection plate and a top surface of respective mounting blocks and/or between a bottom part of the mounting block portion and a bottom surface of the respective mounting blocks.
